(19) United States
(12) Patent Application Publication
(10) Pub. No.: US 2014/0166821 A1
(43) Pub. Date: Jun. 19, 2014

(54) Directional Communication Device for Locomotive Consist Communication

(71) Applicant: ELECTRO-MOTIVE DIESEL, INC., LaGrange, IL (US)

(72) Inventor: Raymond Thomas Kelleher, Joliet, IL (US)

(73) Assignee: Electro-Motive Diesel, Inc., LaGrange, IL (US)

(21) Appl. No.: 13/715,129

(22) Filed: Dec. 14, 2012

(51) Int. Cl. B60L 15/32; H04W 84/18; H04W 4/00

(52) U.S. Cl. CPC B60L 15/32; H04W 4/00; H04W 84/18
USPC 246/187 C; 370/310; 370/254

(57) ABSTRACT

A locomotive consist communication system and method of communication using directional communication devices that allow each locomotive to communicate wirelessly with at least one locomotive directly attached to it. Each of the locomotives is equipped with at least one directional communication device placed on the side of the locomotive directly facing the locomotive attached to it. The locomotive consist communication system forms a communication network running through the consist that allows various locomotives to communicate with each other and share information. This directional wireless communication is resistant to multipath interference, requires less power, and is less likely to be damaged because it is situated on the side of the locomotive facing the locomotive attached to it.

### TECHNICAL FIELD

The present disclosure relates to locomotive consist communication. More particularly, the present disclosure relates to systems and methods for locomotive consist communication using a directional communication device.

### BACKGROUND

A locomotive is a railway vehicle that provides the motive power for a train. Generally, a locomotive carries no payload of its own, and its sole purpose is to move the train along the tracks. In contrast, self-propelled payload-carrying vehicles may be referred to as multiple units, motor coaches or railcars.

A “locomotive consist” is a group of two or more locomotives linked together to travel along a rail. The locomotive consist includes a lead locomotive and one or more trail locomotives that are mechanically coupled. The power and braking systems are also coupled so that the group of locomotives function together as a single unit.

In a locomotive consist, individual locomotives are coupled to each other via a port and jumper commonly referred to in the industry as a multiple unit cable or “MU” cable that allows the on-board controllers in each of the locomotives to communicate with each other. This connection allows the locomotives to communicate with each other, share resources and may form a computer network allowing the exchange of information throughout the consist.

This intra-consist network allows for redundancy in locomotive electronics to improve the reliability of the entire consist by allowing, for example, the lead locomotive to utilize electronic equipment contained in a trailing locomotive. This ensures that an electronic failure in one of the locomotives does not affect the entire locomotive consist.

Intra-consist communication may be accomplished by either using a cable connecting locomotives (such as a network embedded on a MU cable), or wirelessly. So far, wireless communication in a train has been accomplished using Radio Frequency (RF) transmitted through omnidirectional antennas. In such a system, the lead locomotive in the lead consist transmits a strong signal that is capable of traveling far enough to reach the lead locomotive in the remote or farthest consist, Therefore, the lead locomotive is capable of directly communicating with any of the lead locomotives in the train.

The wireless inter-locomotive communication systems in the prior art (see, e.g. U.S. Pat. No. 5,720,455) suffer from multiple shortcomings, including (i) having protruding omni-directional antennas placed on the top of locomotives, which are prone to being damaged; (ii) requiring high power output; and (iii) suffering from multipath interference and reflections. Another limitation of prior art intra-consist communication systems is that they are not limited to communicating with locomotives within their respective train. Manual configuration is necessary to identify which units in a specific train are to be included in the communications system.

There is a need for an intra-consist communication system that overcomes the above-mentioned shortcomings,

### SUMMARY

One aspect of the present disclosure provides an intra-unit communication system for a locomotive consist including a first unit and a second unit directly connected to the first unit. The first unit includes a first directional communication device and a first controller, and the second unit includes a second directional communication device, positioned directly facing the first directional communication device, and a second controller. The first controller is adapted to communicate with the second controller by transmitting data wirelessly from the first directional communication device to the second directional communication device.

Another aspect of the present disclosure provides a method of intra-unit communication in a locomotive consist including transmitting data wirelessly from a first unit to a second unit using a first directional communication device, and receiving the data in the second unit using a second directional communication device.

### BRIEF DESCRIPTION OF THE DRAWINGS

FIG. 1 is a diagram of locomotive consist equipped with a wireless communication system using directional transmitters and receivers, according to an embodiment of the present invention;

FIG. 2 is a diagram demonstrating wireless communication between directional transmitters/receivers, according to an embodiment of the present invention.

FIG. 3 is a schematic diagram of a communication system for communicating data in a locomotive consist, according to an embodiment of the present invention.

FIG. 4 is a schematic diagram of a controller for controlling the communication system, according to an embodiment of the present invention.

### DETAILED DESCRIPTION

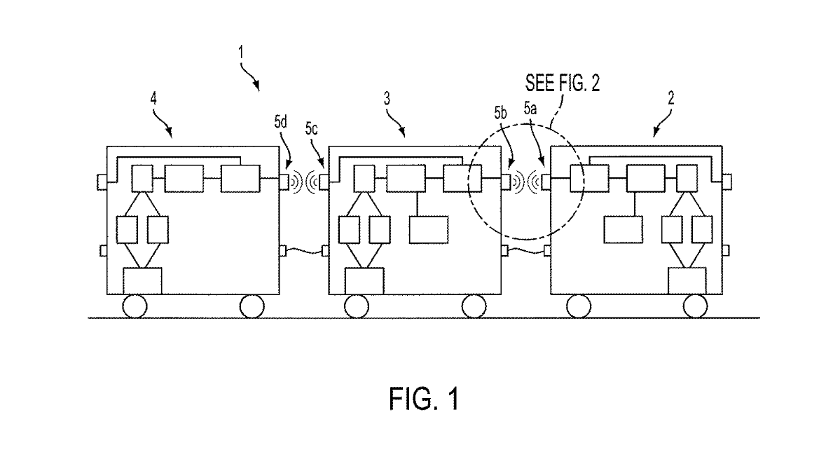

FIG. 1 is a diagram of a communication system for communicating data in a locomotive consist, according to an embodiment of the present invention. Locomotive consist (1) includes a group of two or more locomotives (2, 3 and 4) linked together to travel along a rail. The locomotives are equipped with directional communication devices (5a, 5b, 5c, 5d) positioned on the front and the back of each locomotive. The directional communication devices (5a-5b and 5c-5d) are facing each other to facilitate communication between locomotives that is free of multipath interference.

Locomotives may need to communicate and share data relating to acceleration, deceleration, or various measurements collected from various sensors throughout the consist. The data transmitted via wireless communication devices (5a-5b) may travel from locomotive (2) to locomotive (4) (and any other locomotive in the consist) through locomotive (3), forming a network of data exchange throughout the consist.

For example, a leading locomotive may communicate with the last trailing locomotive to coordinate acceleration and deceleration. In the event that a sensor malfunctions in locomotive (2), the identical sensor in locomotive (3) or locomotive (4) may communicate the sensor information through the data network to locomotive (2). This redundancy ensures the continued operation of the consist regardless of the occasional failure of certain sensors. The data network between locomotives may use packet switching for transmitting the data throughout the network. locomotives may be identified using an Internet Protocol (IP) address.

The data exchanged between locomotives may be encrypted for security purposes. For example, event recorder data may be encrypted and exchanged between locomotives and saved on multiple locomotives. An encryption module may be integrated within the control unit, or may be separate from the control unit.

The decentralization of information flow eliminates the need to use any particular locomotive as the leading locomotive. As a result, locomotives are easily and effectively swapped, and any locomotive may act as either a leading or trailing locomotive.

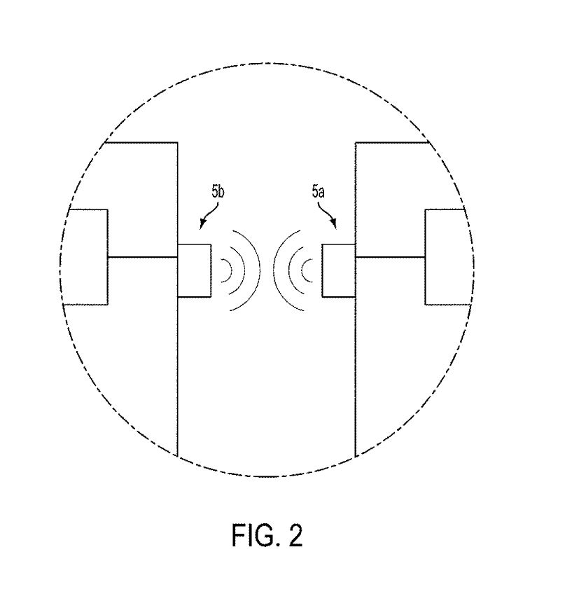

FIG. 2 is a diagram demonstrating wireless communication between directional communication devices (5a-5b), according to an embodiment of the present invention. Directional wireless communication devices (5a-5b) may communicate data from one locomotive to another using Radio Frequency (RF), acoustic frequency, or light frequency, including for example laser or infrared light.

The signal transmitted by the wireless communication devices may be modulated in various forms, including frequency modulation or amplitude modulation.

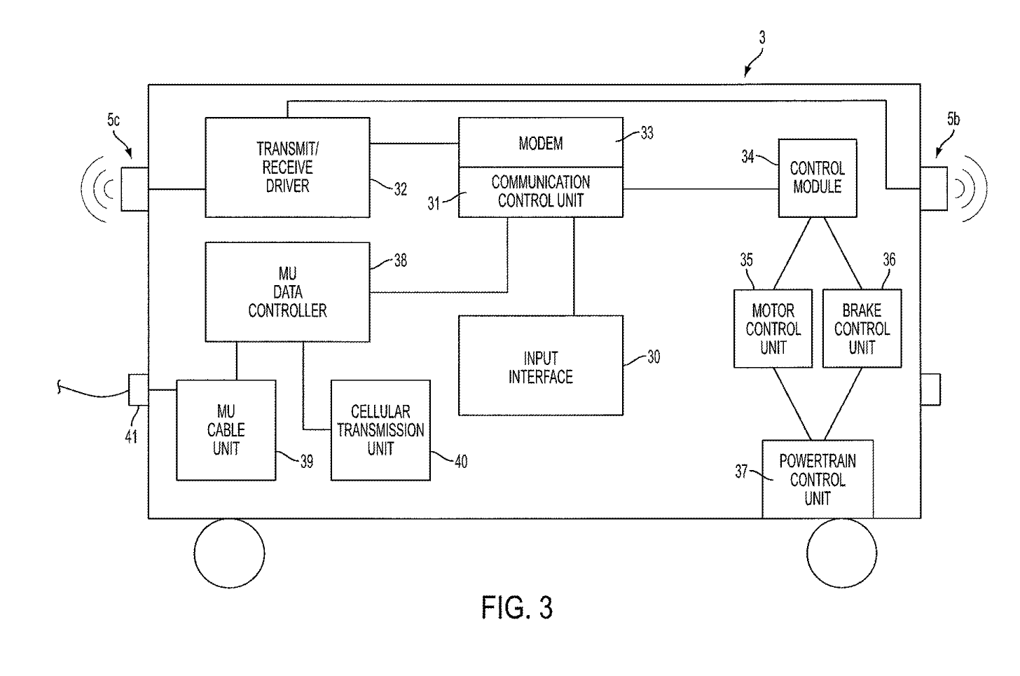

FIG. 3 is a schematic diagram of a communication system for controlling data communicating in a locomotive consist, according to an embodiment of the present invention. Communication devices (5b-5c) are connected to, and driven by, the Transmit/Receive Driver (32). The Modem (33) modulates and demodulates the signals received/transmitted from/to the Transmit/Receive Driver (32) and communicates the data to the Communication Control Unit (31), which may be equipped with hardware and software for controlling the data exchange between locomotives. Communication Control Unit (31) may also receive instructions from Input Interface (30), which may include a keyboard, a touch screen, a personal computer, a pad, a mobile device or a panel of switches.

Additionally, Communication Control Unit (31) communicates with Control Module (34), which communicates acceleration/deceleration commands to the Powertrain Control Unit (37) through the Motor Control Unit (35) and the Brake Control Unit (36).

While FIG. 3 illustrates communication relating to the acceleration and deceleration of locomotives, the flow of information is not limited to this type of data. As mentioned above, data from various sensors in various locomotives may be collected by any locomotive in the consist. Communication Control Unit (31) is connected to locomotive Data Controller (38) which is capable of performing various calculations and storing data for archiving and later use.

Locomotive Data Controller (38) is connected to MU Cable Unit (39), which may communicated the data saved in locomotive Data Controller (38) via the MU Cable Connector (41). Locomotive Data Controller (38) is also connected to Cellular Transmission Unit (40), which is capable of transmitting the data via a cellular network or a WIFI network.

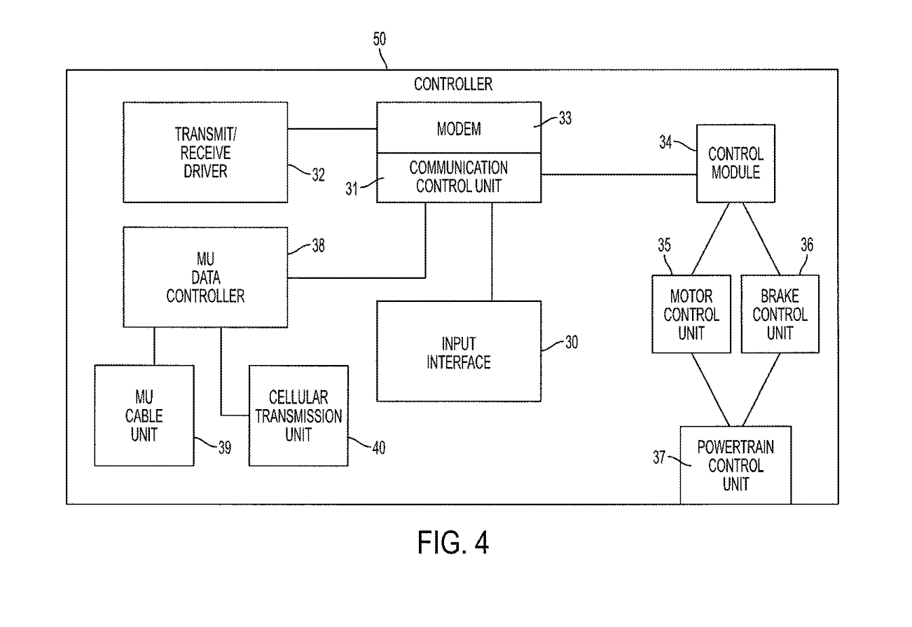

FIG. 4 is a schematic diagram of a controller for controlling the communication system, according to an embodiment of the present invention.

Controller 50 in FIG. 4 may be modular so that it may be easily replaced interchanged from one locomotive to another.

### INDUSTRIAL APPLICABILITY

Locomotive consist communication systems of the prior art require that the lead locomotive be equipped with a powerful omnidirectional transmission device situated on the top of the lead locomotive so that it may communicate with each of the locomotives in the consist. This is a centralized communication network setup that requires the lead locomotive to be equipped with special hardware controllers. In the event of a failure of the communication system in the lead locomotive, the entire locomotive consist would be affected.

The present disclosure was born out of a long-felt industrial need to decentralize the communication system in a locomotive consist, and to create a redundant network that can support the reliable operation of the locomotive consist.

The present disclosure was also born out of a long-felt industrial need to easily and efficiently interchange a lead locomotive with a trailing locomotive without requiring any hardware upgrades to the communication network throughout the consist.

The above description is illustrative only, not restrictive. Embodiments and aspects thereof may be used in combination with each other. Additionally, various modifications may be made to the above teachings to adapt a solution to a particular problem without departing from the scope of the invention. Dimensions and types of materials described in the description of this invention are merely exemplary embodiments, they are not intended to be limiting. Various additional embodiments could be apparent to those skilled in the art. Therefore, the scope of the invention should be determined with reference to the appended claims, along with the full scope of equivalents to which such claims are entitled.

This above specification of this invention uses various examples to describe several embodiments of the invention, including the best mode. The patentable scope of the invention is defined by the claims, and is not limited by the above mentioned examples. A person skilled in the art may identify other examples that fall within the scope of the invention.

Additionally, the foregoing description of certain embodiments of the present invention may be better understood when read in conjunction with the drawings. The functional blocks in the drawings of various embodiments are not necessarily indicative of the division between hardware circuitry. Therefore, one or more of the functional blocks may be implemented in a single piece of hardware. For clarity, the various embodiments are not limited to the arrangements and instrumentalities shown in the drawings.

An element or step recited in the singular (i.e., “a” or “an”) should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Additionally, unless explicitly stated to the contrary, embodiments “comprising,” “including,” or “having” an element or a plurality of elements having a particular property may include additional such elements not having that property.

Certain modifications may be made in the methods and systems described herein for communicating data in a vehicle consist without departing from the spirit and scope of the invention. Therefore, the above description, including the accompanying drawings, are intended to be interpreted as mere examples illustrating the inventive concept and shall not be construed as limiting the invention.

What is claimed is:

1. An intra-unit communication system for a locomotive consist, comprising:
a first unit, including:
a first directional communication device, and
a first controller; and
a second unit, directly connected to the first unit, including:
a second directional communication device positioned directly facing the first directional communication device, and
a second controller,
wherein the first controller is adapted to communicate with the second controller by transmitting data wirelessly from the first directional communication device to the second directional communication device.

2. The intra-unit communication system according to claim 1, wherein the first directional communication device and the second directional communication device include directional radio frequency antennas.

3. The intra-unit communication system according to claim 1, wherein the first directional communication device and the second directional communication device include optical communication devices.

4. The intra-unit communication system according to claim 1, wherein the first directional communication device and the second directional communication device include acoustic communication devices.

5. The intra-unit communication system according to claim 1, further comprising a third unit including a third directional communication device and a third controller, wherein the third controller communicates with the first controller through the second controller.

6. The intra-unit communication system according to claim 1, wherein the first unit includes a first encryption module and the second unit includes a second encryption module.

7. The intra-unit communication system according to claim 5, wherein the first controller, the second controller and the third controller form a network.

8. The intra-unit communication system according to claim 1, wherein the data includes motor control unit commands.

9. The intra-unit communication system according to claim 1, wherein the data includes brake control unit commands.

10. The intra-unit communication system according to claim 1, wherein the data includes sensory information.

11. The intra-unit communication system according to claim 1, wherein the data includes payload information.

12. The intra-unit communication system according to claim 1, wherein the first controller includes a first cellular transmission module and the second controller includes a second cellular transmission module.

13. A method of intra-unit communication in a locomotive consist, comprising:
transmitting data wirelessly from a first unit to a second unit using a first directional communication device; and
receiving the data in the second unit using a second directional communication device.

14. The method of intra-unit communication according to claim 13, further comprising:
modulating the data transmitted through the first directional communication device; and
demodulating the data received through the second directional communication device.

15. The method of intra-unit communication according to claim 13, further comprising:
encrypting the data transmitted through the first directional communication device; and
unencrypting the data received through the second directional communication device.

16. The method of intra-unit communication according to claim 13, further comprising controlling a motor control unit using the data received by the second unit.

17. The method of intra-unit communication according to claim 13, further comprising controlling a brake control unit using the data received by the second unit.

18. The method of intra-unit communication according to claim 13, further comprising transmitting the data using a cellular transmission unit.

19. The method of intra-unit communication according to claim 13, further comprising communicating data between the first unit and a third unit through the second unit.

20. The method of intra-unit communication according to claim 13, further comprising forming a data network between the first and second unit.
